(19) United States
(12) Patent Application Publication
(10) Pub. No.: US 2015/0274417 A1
(43) Pub. Date: Oct. 1, 2015

(54) WASTE RECEPTACLE WITH SLIDING DOOR AND RELATED METHODS

(71) Applicant: Rachel Y. Feanny, Pembroke Pines, FL (US)

(72) Inventor: Rachel Y. Feanny, Pembroke Pines, FL (US)

(21) Appl. No.: 14/230,289

(22) Filed: Mar. 31, 2014

(51) Int. Cl. B65F 1/06; B23P 19/04; B65F 1/14

(52) U.S. Cl. CPC B65F 1/068; B65F 1/163; B23P 19/04; B65F 2001/1653

(57) ABSTRACT

A waste receptacle may include a body having an open first end and a closed second end, and first and second longitudinal sides extending between the open first end and the closed second end, the body defining a waste receiving cavity. The first longitudinal side may define an opening for accessing the waste receiving cavity. The waste receptacle may include a rail carried by the body and extending along a periphery of the waste receiving cavity, the rail to receive a liner bag, a lid portion to be received by the open first end, and a door slidingly receiving by the rail and moving between a first position where the door closes the opening and a second position where the door is retracted within the waste receiving cavity.

### TECHNICAL FIELD

The present disclosure relates to the field of waste disposal, and, more particularly, to a waste receptacle and related methods.

### BACKGROUND

Waste receptacles are quite ubiquitous in today's society. Indeed, so prevalent and frequently used are waste receptacles, it is a significant logistical undertaking to maintenance a large number of waste receptacles. Indeed, for institutional users with a large number of customers, such as airports, theme parks, a team of janitorial personnel are dedicated to servicing the waste receptacles.

An approach to a waste receptacle is disclosed in U.S. Patent Application Publication No. 2013/0048641 to Romano. This waste receptacle comprises a hinged side door that opens outwardly and provides access to the disposable liner. This waste receptacle also includes an interlocking trash bag control device coupled to a rim of the waste receptacle.

Another approach to a waste receptacle is disclosed in U.S. Pat. No. 5,984,134 to Mario. This waste receptacle comprises a front panel that opens vertically to provide access to the disposable liner.

### SUMMARY

In view of the foregoing background, it is therefore an object of the present disclosure to provide a waste receptacle that is easy to service and use.

This and other objects, features, and advantages in accordance with the present disclosure are provided by a waste receptacle. The waste receptacle may comprise a body having an open first end and a closed second end, and first and second longitudinal sides extending between the open first end and the closed second end. The body may define a waste receiving cavity therein. The first longitudinal side may define an opening therein for accessing the waste receiving cavity. The waste receptacle may include a rail carried by the body and extending along a periphery of the waste receiving cavity. The rail may receive a liner bag. The waste receptacle may also include a lid portion to be received by the open first end, and a door slidingly receiving by the rail and moving between a first position where the door closes the opening and a second position where the door is retracted within the waste receiving cavity. Advantageously, the waste receptacle may be readily serviced.

More specifically, the rail may comprise a plurality thereof comprising a first rail adjacent the open first end, and a second rail adjacent the closed second end. The first and second rails may each define a groove, and the door may have first and second opposing sides defining respective tongues for cooperating with the respective grooves of the first and second rails.

In some embodiments, the first rail may comprise a retention device for carrying the liner. For example, the retention device may comprise a retention clip.

Additionally, the waste receptacle may further comprise a biasing device for biasing the door in the second position. The waste receptacle may further comprise a latch carried by the body adjacent the opening for maintaining the door in the first position.

For example, the body may be cylindrical in shape. The lid portion may switchingly close the open first end of the body. The waste receptacle may further comprise a foot pedal carried by the body adjacent the closed second end for controlling the lid portion.

Another aspect is directed to a method for making a waste receptacle. The method may include forming a body having an open first end and a closed second end, and first and second longitudinal sides extending between the open first end and the closed second end, the body defining a waste receiving cavity therein. The first longitudinal side may define an opening therein for accessing the waste receiving cavity. The method may include coupling a rail to be carried by the body and to extend along a periphery of the waste receiving cavity. The rail may receive a liner bag. The method may include coupling a lid portion to be received by the open first end, and coupling a door to be slidingly received by the rail and move between a first position where the door closes the opening and a second position where the door is retracted within the waste receiving cavity.

### BRIEF DESCRIPTION OF THE DRAWINGS

FIG. 1 is a schematic diagram of a perspective view of a waste receptacle, according to the present disclosure.

FIG. 2 is a partial internal view of the rails from the waste receptacle of FIG. 1.

FIG. 3 is a partial cross-sectional view of the second rail from the waste receptacle of FIG. 1.

### DETAILED DESCRIPTION

The present disclosure will now be described more fully hereinafter with reference to the accompanying drawings, in which several embodiments of the invention are shown. This present disclosure may, however, be embodied in many different forms and should not be construed as limited to the embodiments set forth herein. Rather, these embodiments are provided so that this disclosure will be thorough and complete, and will fully convey the scope of the present disclosure to those skilled in the art. Like numbers refer to like elements throughout.

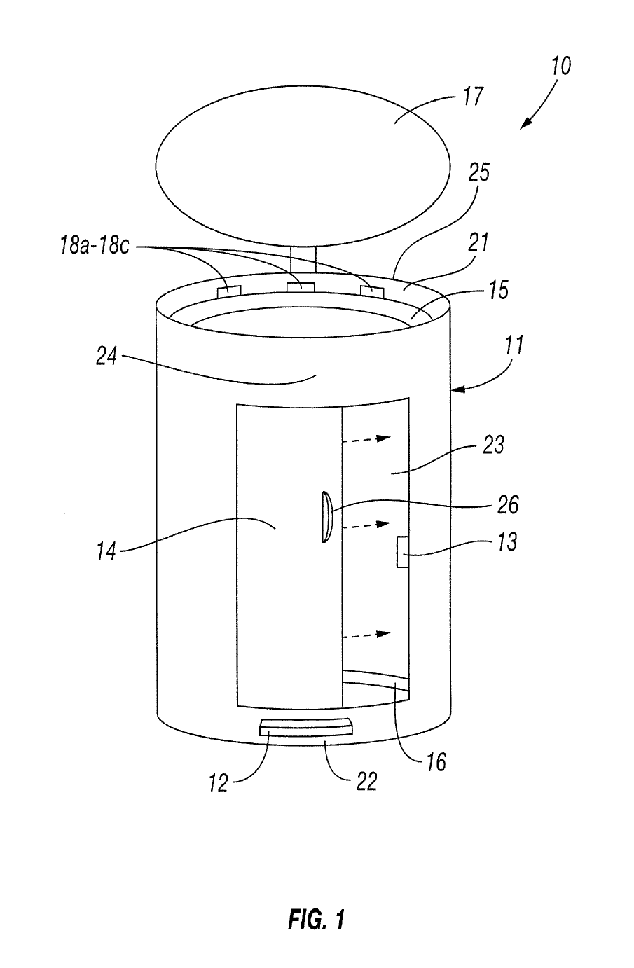

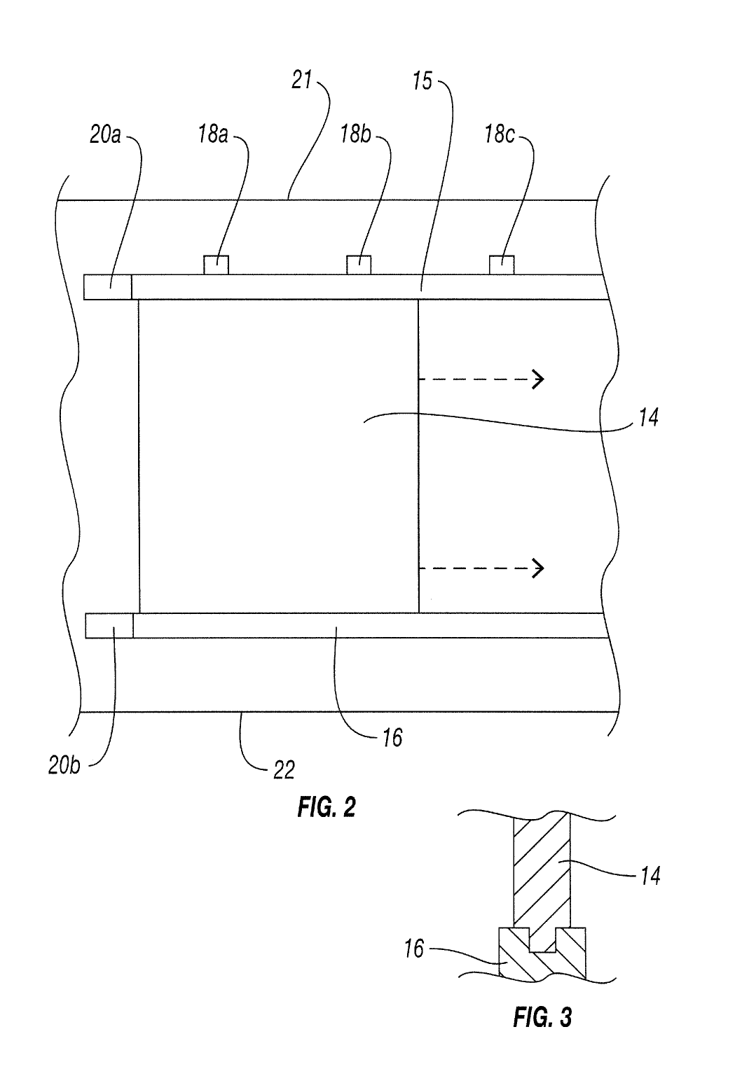

Referring to FIGS. 1-3, a waste receptacle 10 according to the present disclosure is now described. The waste receptacle 10 includes a body 11 having an open first end 21 and a closed second end 22, and first and second longitudinal sides 24, 25 extending between the open first end and the closed second end. The body 11 defines a waste receiving cavity 23 therein. The first longitudinal side 24 illustratively defines an opening therein for accessing the waste receiving cavity 23. For example, in the illustrated embodiment, the body 11 has a cylindrical shape, but in other embodiments, the body may have a rectangular box shape.

The waste receptacle 10 illustratively includes first and second rails 15, 16 carried by an internal surface of the body 11 and extending along a periphery of the waste receiving cavity 23. The first rail 15 is adjacent the open first end 21, and the second rail 16 is adjacent the closed second end 22. Depending on the size of the opening and the circumference of the body 11, the first and second rails 15, 16 may extend around the entire peripheral edge of the body.

As will be appreciated, the first rail 15 may receive a liner bag (i.e. the typical disposable trash bag). In the illustrated embodiment, the first rail 15 comprises a retention device 18a-18c for attaching to the liner bag. For example, the retention device 18a-18c may comprise a retention clip or an adhesive strip. In other embodiments, the retention device 18a-18c may comprise jagged teeth for lodging in the liner bag material.

The waste receptacle 10 illustratively includes a lid portion 17 to be received by the open first end 21, and a hinge for coupling the lid portion to the body 11. The lid portion may switchingly close the open first end of the body 11. The waste receptacle illustratively includes a foot pedal 12 carried by the body 11 adjacent the closed second end 22 for controlling the lid portion 17. In other embodiments, the waste receptacle 10 may comprise a motor for opening and closing the lid portion 17. The waste receptacle 10 may also include a proximity detector for detecting when a user is adjacent the waste receptacle and activating the motor to open the lid portion 17.

The waste receptacle 10 illustratively includes a door 14 slidingly receiving by the first and second rails 15, 16 and moving between a first position where the door closes the opening and a second position where the door is retracted within the waste receiving cavity 23, i.e. a servicing mode position. In other words, the door 14 operates as a “pocket door” or a “bread box door,” i.e. fully retracting within the waste receptacle 10 when opened. The door 14 illustratively includes a handle 26 for permitting a user easy grip thereof. In FIG. 1, the dashed arrows note the movement of the door 14 midway from the second position to the first position.

As perhaps best seen in FIG. 3, the first and second rails 15, 16 each defines a groove, and the door 14 has first and second opposing sides defining respective tongues for cooperating with the respective grooves of the first and second rails. The tongue and groove interface of the first and second rails 15, 16 and the door 14 may also include ball bearings to reduce friction. Additionally, the waste receptacle 10 illustratively includes a biasing device 20a-20b for biasing the door 14 in the second position. In other embodiments, the biasing device 20a-20b may bias the door 14 in the first position.

The biasing device 20a-20b is carried on an internal surface of the body 11 and is also coupled to the door 14. The biasing device 20a-20b may comprise a biasing spring (e.g. coiled spring) or a pressurized piston. The waste receptacle 10 illustratively includes a latch 13 carried by the body 11 adjacent the opening for maintaining the door 14 in the first position. The latch 13 may comprise, for example, a magnet or a hook.

Advantageously, when the waste receptacle 10 is serviced by janitorial personnel, the process is quick and efficient. The user first disables the latch 13 on the door 14, and due to the biasing device 20a-20b, the door 14 automatically opens, providing quick access to the liner bag (i.e. providing a one-touch opening mechanism). Once the user swaps out the liner bag, the user repositions the door 14 in the closed first position and enables the latch 13. Moreover, since the door 14 opens and closes internally and without swinging wide as in prior art approaches, the waste receptacle 10 consumes little space, even during servicing, which can be helpful to institutional users that must service the receptacles during heavy traffic operational hours.

Another aspect is directed to a method for making a waste receptacle 10. The method may include forming a body 11 having an open first end 21 and a closed second end 22, and first and second longitudinal sides 24, 25 extending between the open first end and the closed second end, the body defining a waste receiving cavity 23 therein. The first longitudinal side 24 may define an opening therein for accessing the waste receiving cavity 23. The method may include coupling a rail 15, 16 to be carried by the body 11 and to extend along a periphery of the waste receiving cavity 23, the liner bag to be receive by the rail, coupling a lid portion 17 to be received by the open first end 21, and coupling a door 14 to be slidingly received by the rail and move between a first position where the door closes the opening and a second position where the door is retracted within the waste receiving cavity.

Many modifications and other embodiments of the present disclosure will come to the mind of one skilled in the art having the benefit of the teachings presented in the foregoing descriptions and the associated drawings. Therefore, it is understood that the present disclosure is not to be limited to the specific embodiments disclosed, and that modifications and embodiments are intended to be included within the scope of the appended claims.

That which is claimed is:

1. A waste receptacle comprising:
a body having an open first end and a closed second end, and first and second longitudinal sides extending between the open first end and the closed second end, said body defining a waste receiving cavity therein;
said first longitudinal side defining an opening therein for accessing the waste receiving cavity;
a rail carried by said body and extending along a periphery of the waste receiving cavity, said rail to receive a liner bag;
a lid portion to be received by the open first end; and
a door slidingly receiving by said rail and moving between a first position where said door closes the opening and a second position where said door is retracted within the waste receiving cavity.

2. The waste receptacle of claim 1 wherein said rail comprises a plurality thereof comprising a first rail adjacent the open first end, and a second rail adjacent the closed second end.

3. The waste receptacle of claim 2 wherein said first and second rails each defines a groove; and said door has first and second opposing sides defining respective tongues for cooperating with the respective grooves of said first and second rails.

4. The waste receptacle of claim 2 wherein said first rail comprises a retention device for carrying the liner bag.

5. The waste receptacle of claim 4 wherein said retention device comprises a retention clip.

6. The waste receptacle of claim 1 further comprising a biasing device for biasing said door in the second position.

7. The waste receptacle of claim 6 further comprising a latch carried by said body adjacent the opening for maintaining said door in the first position.

8. The waste receptacle of claim 1 wherein said body is cylindrical in shape.

9. The waste receptacle of claim 1 wherein said lid portion switchingly closes the open first end of said body.

10. The waste receptacle of claim 9 further comprising a foot pedal carried by said body adjacent the closed second end for controlling said lid portion.

11. A method for making a waste receptacle comprising:
forming a body having an open first end and a closed second end, and first and second longitudinal sides extending between the open first end and the closed second end, the body defining a waste receiving cavity therein;
the first longitudinal side defining an opening therein for accessing the waste receiving cavity;
coupling a rail to be carried by the body and to extend along a periphery of the waste receiving cavity, the rail to receive a liner bag;
coupling a lid portion to be received by the open first end; and
coupling a door to be slidingly received by the rail and move between a first position where the door closes the opening and a second position where the door is retracted within the waste receiving cavity.

12. The method of claim 11 wherein the rail comprises a plurality thereof comprising a first rail adjacent the open first end, and a second rail adjacent the closed second end.

13. The method of claim 12 wherein the first and second rails each defines a groove; and the door has first and second opposing sides defining respective tongues for cooperating with the respective grooves of the first and second rails.

14. The method of claim 12 wherein the first rail comprises a retention device for carrying the liner bag.

15. The method of claim 14 wherein the retention device comprises a retention clip.

16. The method of claim 11 further comprising coupling a biasing device to bias the door in the second position.

17. The method of claim 16 further comprising coupling a latch to be carried by the body adjacent the opening for maintaining the door in the first position.

18. The method of claim 11 wherein the body is cylindrical in shape.

19. The method of claim 11 wherein the lid portion switchingly closes the open first end of the body.

20. The method of claim 19 further comprising coupling a foot pedal to be carried by the body adjacent the closed second end for controlling the lid portion.
